(19) United States
(12) Patent Application Publication
(10) Pub. No.: US 2026/0022940 A1
(43) Pub. Date: Jan. 22, 2026

(54) QR CODE-BASED INDOOR MAP PROVIDING DEVICE, METHOD, AND COMPUTER PROGRAM INCLUDING THE SAME

(71) Applicant: Freegrow Inc., Busan (KR)

(72) Inventor: Young Sik KIM, Busan (KR)

(73) Assignee: Freegrow Inc., Busan (KR)

(21) Appl. No.: 18/925,031

(22) Filed: Oct. 24, 2024

(30) Foreign Application Priority Data
Jul. 22, 2024 (KR) 10-2024-0096094
Jul. 22, 2024 (KR) 10-2024-0096095

(51) Int. Cl. G01C 21/20; G06K 7/14

(52) U.S. Cl. CPC G01C 21/206; G06K 7/1413; G06K 7/1417

(57) ABSTRACT

The present invention relates to a QR code-based indoor map providing apparatus, which, as an electronic device, includes: a memory containing at least one instruction; and at least one processor electrically connected to the memory and configured to execute the at least one instruction, wherein the at least one processor may receive input from a user terminal regarding a barcode—the barcode is located in an indoor environment and provides an entry point to access the indoor map on the user terminal—determine the position and direction of the user terminal on the indoor map based on the position and direction corresponding to the barcode, generate an indoor map setting that reflects the position and direction of the user terminal on the indoor map, and provide the indoor map setting to the user terminal.

### CROSS-REFERENCE TO RELATED APPLICATIONS

This application claims priority to Korean Patent Application No. 10-2024-0096094 filed on Jul. 22, 2024, and Korean Patent Application No. 10-2024-0096095 filed on Jul. 22, 2024, which are incorporated by reference herein in their entirety.

### BACKGROUND

### 1. Field

The present invention relates to QR code-based indoor map provision technology. The present invention relates to QR code-interlinked indoor navigation technology.

### 2. Description of Related Art

Location-based services play a crucial role in various industries such as navigation, logistics, and tourism. In particular, technology that provides routes based on the user's location is essential. While GPS technology provides accurate positioning outdoors, its accuracy diminishes indoors due to signal limitations. To address this issue, various indoor positioning technologies have been developed.

Traditional indoor location tracking technologies include Wi-Fi, Bluetooth, and UWB. These technologies have limited use due to cost, accuracy, and other issues.

The present invention seeks to solve these problems by using a barcode to determine the user's location, generate a route, and provide it to the user's terminal in order to provide indoor-based navigation.

Additionally, an indoor route guidance system utilizing kiosks is gaining attention as an effective solution to these issues. Kiosks are already widely used in various public places, commercial spaces, hospitals, and universities, making the additional installation cost low and easily accessible to users. Users can input their desired destination through the kiosk, generate an indoor route, and the generated route is provided in the form of a QR code.

### SUMMARY

An embodiment of the present invention relates to a QR code-based indoor map provision device that can identify the location of the user's terminal through a QR code and provide information related to that location to the user's terminal.

An embodiment of the present invention relates to a QR code-based indoor map provision device that can generate an indoor route based on the location of the user's terminal and provide it to the user's terminal.

An embodiment of the present invention relates to a QR code-interlinked indoor navigation technology that can generate an indoor route through a user interface device and create a QR code containing information about the route.

An embodiment of the present invention relates to a QR code-interlinked indoor navigation technology that can generate an indoor route by selecting and displaying an inter-floor transportation means when such means exist between the starting point and the destination.

An embodiment of the present invention relates to a QR code-interlinked indoor navigation technology in which the indoor route generated through a user interface device and server is consistently structured, allowing the user to easily check the indoor route via the user's terminal.

The present invention relates to a barcode-based indoor map provision device according to one embodiment of the invention, comprising, a memory comprising at least one instruction; and at least one processor electrically connected to the memory and configured to execute the at least one instruction, wherein the at least one processor: receives an input for a barcode from a user terminal, the barcode being located in an indoor environment and providing an entry for the user terminal to access an indoor map, determines a position and orientation of the user terminal on the indoor map based on a position and orientation corresponding to the barcode, generates an indoor map setting incorporating the position and orientation of the user terminal on the indoor map; and provides the indoor map setting to the user terminal.

The barcode may be a QR code.

The position of the user terminal may include a layer and coordinates.

The at least one processor may determine the orientation of the user terminal as the frontal direction of the barcode located in the layer and coordinates.

The at least one processor may determine the orientation of the user terminal with north as the default value.

The at least one processor may generate the indoor map setting, which includes the position and orientation of the user terminal on the indoor map and an input window for entering a destination.

The at least one processor may generate a route from the position and orientation of the user terminal to the destination in response to receiving the destination in the input window of the indoor map setting from the user terminal.

The route from the position and orientation of the user terminal to the destination may include multiple segmented routes, the segmented routes including sub-start and sub-destination points.

The at least one processor may determine a straight line direction from the sub-start to the sub-destination point as an optimal direction and generate the route from the position and orientation of the user terminal to the destination, displaying the segmented route in the optimal direction on the user terminal.

The at least one processor may generate the indoor map setting to include a display of the position and orientation of the user terminal on the indoor map and an address for sharing the location of the user terminal.

The present invention relates to a barcode-based indoor map provision method according to one embodiment, performed by a memory and at least one processor electrically connected to the memory, comprising: receiving an input for a barcode from a user terminal, the barcode being located in an indoor environment and providing an entry for the user terminal to access an indoor map; determining the position and orientation of the user terminal on the indoor map based on a position and orientation corresponding to the barcode; generating an indoor map setting incorporating the position and orientation of the user terminal on the indoor map; and providing the indoor map setting to the user terminal.

The present invention relates to a computer program recorded on a computer-readable recording medium according to one embodiment, which is combined with hardware and can perform the barcode-based indoor map provision method.

The present invention relates to a barcode-interlinked indoor navigation device according to one embodiment, comprising an electronic device with a memory comprising at least one instruction, and at least one processor electrically connected to the memory and configured to execute the at least one instruction. The at least one processor: receives a route generation request from a user interface device, generates an indoor route including a starting point and a destination corresponding to the route generation request, generates a barcode containing information about the indoor route, and provides the information of the indoor route to a user terminal that reads the barcode.

The route generation request may include a starting point, a destination, and an inter-floor transportation means.

The indoor route may include a floor-by-floor travel path that incorporates the inter-floor transportation means.

The indoor route may comprise multiple segmented routes, the segmented routes comprising sub-start and sub-destination points.

The at least one processor may determine a straight line direction from the sub-start to the sub-destination point as the minimum direction and generate the route from the starting point to the destination, displaying the segmented route in the minimum direction on the user terminal.

The information of the indoor route may comprise information about the starting point, the destination, and the inter-floor transportation means.

The present invention relates to a barcode-interlinked indoor navigation system according to one embodiment, comprising a system with: a user interface device that receives user input; a user terminal that displays an indoor route; a memory comprising at least one instruction; and at least one processor electrically connected to the memory and configured to execute the at least one instruction. The user interface device receives a route generation request, generates a first indoor route including a starting point and a destination corresponding to the route generation request, and generates a barcode containing information about the first indoor route. The at least one processor, in response to reading the barcode through the user terminal, generates a second indoor route and provides the second indoor route to the user terminal.

The information of the first indoor route may comprise information about the starting point, the inter-floor transportation means, and the destination.

The at least one processor may generate a second indoor route identical to the first indoor route based on the information of the first indoor route.

The second indoor route may comprise multiple segmented routes, the segmented routes comprising sub-start and sub-destination points.

The user terminal may display the segmented routes on a single screen.

The present invention relates to a barcode-interlinked indoor navigation method according to one embodiment, comprising: receiving a route generation request via a user interface device; generating a first indoor route that includes a starting point and a destination corresponding to the route generation request; and generating a barcode containing information about the first indoor route. The method, performed by a memory and at least one processor electrically connected to the memory, further comprises generating a second indoor route in response to reading the barcode through a user terminal, and providing the second indoor route to the user terminal.

The disclosed technology may have the following effects. However, this does not mean that a specific embodiment must include all of the following effects or only include the following effects. Therefore, the scope of rights of the disclosed technology should not be understood as being limited by these effects.

The present invention relates to a barcode-based indoor map provision device according to one embodiment, which identifies the location of the user terminal through a QR code and provides information related to that location to the user terminal.

The present invention relates to a barcode-based indoor map provision device according to one embodiment, which generates an indoor route based on the location of the user terminal and provides it to the user terminal.

The present invention relates to a barcode-interlinked indoor navigation technology according to one embodiment, which generates an indoor route through a user interface device and creates a barcode containing information about the route.

The present invention relates to a barcode-interlinked indoor navigation technology according to one embodiment, which generates an indoor route by selecting and displaying an inter-floor transportation means when such means exist between the starting point and the destination.

The present invention relates to a barcode-interlinked indoor navigation technology according to one embodiment, in which the indoor route generated through a user interface device and a server is consistently structured, allowing the user to easily check the indoor route via the user terminal.

### BRIEF DESCRIPTION OF THE DRAWINGS

FIG. 1 relates to a QR code-based indoor map provision system according to one embodiment of the present invention.

FIG. 2 is a diagram illustrating the physical configuration of a QR code-based indoor map provision device or a QR code-interlinked indoor navigation device according to one embodiment of the present invention.

FIG. 3 is a diagram illustrating the functional configuration of a QR code-based indoor map provision device according to one embodiment of the present invention.

FIG. 4 is a diagram illustrating a QR code according to one embodiment of the present invention.

FIG. 5 is a diagram illustrating the placement of a QR code in an indoor space according to one embodiment of the present invention.

FIG. 6 is a diagram illustrating the provision of an indoor map setting according to one embodiment of the present invention.

FIG. 7 is a diagram illustrating an indoor route according to one embodiment of the present invention.

FIG. 8 is a diagram illustrating a sub-route according to one embodiment of the present invention.

FIG. 9 is a diagram illustrating the direction of the sub-route according to one embodiment of the present invention.

FIG. 10 is a flowchart illustrating the sequence of the QR code-based indoor map provision method according to one embodiment of the present invention.

FIG. 11 relates to a QR code-interlinked indoor navigation system according to one embodiment of the present invention.

FIG. 12 is a diagram illustrating the functional configuration of a QR code-interlinked indoor navigation system according to one embodiment of the present invention.

FIG. 13 is a diagram illustrating a user interface device according to one embodiment of the present invention.

FIG. 14 is a diagram illustrating an interface for receiving a route request according to one embodiment of the present invention.

FIG. 15 is a diagram illustrating an indoor route and a QR code according to one embodiment of the present invention.

FIG. 16 is a diagram illustrating a method for displaying an indoor route via a user terminal according to one embodiment of the present invention.

FIG. 17 is a diagram illustrating the sequence of the QR code-interlinked indoor navigation method according to one embodiment of the present invention.

### DETAILED DESCRIPTION

The description of the invention is by way of structural or functional illustration only, and the scope of the invention is not to be construed as limited by the embodiments described herein, since embodiments are subject to various modifications and may take many forms, and the scope of the invention is to be understood to include equivalents capable of realizing the technical idea. Furthermore, the purposes or effects set forth in the present invention do not imply that a particular embodiment must include all of them or only those effects, and the scope of the present invention should not be understood to be limited thereby.

On the other hand, the meanings of the terms used in this application are to be understood as follows.

The terms “first,” “second,” and the like are intended to distinguish one component from another, and the scope of the claims is not to be limited by these terms. For example, a first component may be named as a second component, and similarly, a second component may be named as a first component.

When a component is described as being “connected to” another component, it may be directly connected to the other component or other components may be present in between. In contrast, when a component is described as being “directly connected to” another component, it means no other components are present in between. Other expressions describing the relationship between components, such as “between” and “directly between,” or “adjacent to” and “directly adjacent to,” should be interpreted similarly.

Expressions of the singular shall be understood to include the plural unless the context clearly indicates otherwise, and terms such as “includes” or “has” shall be understood to designate the presence of a feature, number, step, action, component, part, or combination thereof as practiced and not to preclude the possibility of the presence or addition of one or more other features, numbers, steps, actions, components, parts, or combinations thereof.

The identification of each step (e.g., a, b, c, etc.) is used for convenience of description only, and the identification does not describe the order of the steps, and the steps may occur in any order other than that specified unless the context clearly indicates a particular order, i.e., the steps may occur in the same order as specified, may be performed substantially simultaneously, or may be performed in the opposite order.

The present invention may be implemented as computer-readable code on a computer-readable recording medium, which includes any type of recording device that stores data readable by a computer system. Examples of computer-readable recording media include ROM, RAM, CD-ROM, magnetic tape, floppy disks, optical data storage devices, and may also include transmission media such as carrier waves (e.g., transmission over the internet). Furthermore, the computer-readable recording medium may be distributed across a network-connected computer system so that the code is stored and executed in a distributed manner.

All terms used herein have the same meaning as commonly understood by one of ordinary skill in the field to which the present invention belongs, unless otherwise defined. Terms defined in commonly used dictionaries are to be interpreted as consistent with their meaning in the context of the relevant art and are not to be construed as having an idealized or unduly formal meaning unless expressly defined in this application.

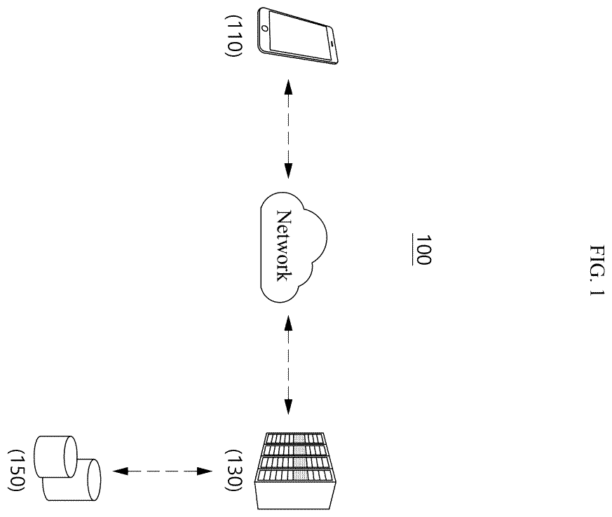

Referring to FIG. 1, the system (100) may include a user terminal (110), an electronic device (130), and a database (150).

The user terminal (110) may be implemented as a smartphone or wearable device that can verify data generated by the electronic device (130) and the analyzed metadata, and it is not limited to these; it may also be implemented on various devices such as tablet PCs. The user terminal (110) may connect to the electronic device (130) through a network, and multiple user terminals (110) may connect to the electronic device (130) simultaneously.

In one embodiment, the user terminal (110) may display the segmented routes on a single screen. Here, the segmented route refers to the path from a sub-start to a sub-destination, and the indoor route may comprise multiple segmented routes. In other words, the indoor route can be displayed on the user terminal (110) at once, and the user can view the indoor route in more detail through the segmented routes. The indoor route and segmented routes will be described in more detail below.

The electronic device (130) may include a barcode-based indoor map provision device. The electronic device (130) can be provided in a computer-readable recording medium, typically implementing a program of commands to achieve this functionality. In other words, the electronic device (130) may be implemented in the form of program instructions that can be executed through various computer means, and can be recorded on a computer-readable recording medium. Additionally, the electronic device (130) may receive an input for a barcode from the user terminal (110), determine the location of the user terminal (110), and reflect this on the indoor map to generate an indoor map setting. It can perform these operations sequentially or non-sequentially through a computer program, and the computer program may be stored on a computer-readable recording medium.

The database (150) may serve as a storage device that receives input for a barcode from the user terminal (110), determines the location of the user terminal (110), reflects this information on the indoor map to generate an indoor map setting, and provides the indoor map setting to the user terminal (110), thereby storing various information generated through this process.

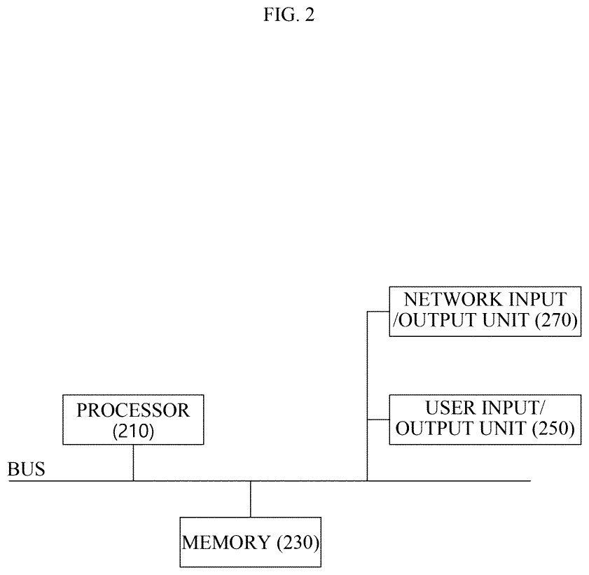

FIG. 2 is a diagram illustrating the physical configuration of the electronic device (130) according to one embodiment. Referring to FIG. 2, the electronic device (130) may be implemented to include a processor (210), a memory (230), a user input/output unit (250), and a network input/output unit (270).

The processor (210) may include at least one processor that is implemented to provide at least some different functions. The processor (210) can control the overall operation of the electronic device (130) and is electrically connected to the memory (230), the user input/output unit (250), and the network input/output unit (270) to control the data flow between them. The processor (210) may be implemented as the CPU (Central Processing Unit) of the electronic device (130).

According to one embodiment, the processor (210) may include a main processor (e.g., a central processing unit or application processor) and an auxiliary processor that can operate independently or together (e.g., a graphics processing unit, neural processing unit (NPU), image signal processor, sensor hub processor, or communication processor). For example, if the electronic device (130) includes both a main processor and an auxiliary processor, the auxiliary processor may use less power than the main processor or be configured to specialize in designated functions.

The auxiliary processor can be implemented separately from the main processor or as part of it. The auxiliary processor can control at least some functions or states related to at least one component of the electronic device (130), either in place of the main processor while it is in an inactive state (e.g., sleep) or alongside the main processor while it is in an active state (e.g., running applications). According to one embodiment, the auxiliary processor (e.g., an image signal processor or communication processor) may be implemented as part of another functionally related component.

According to one embodiment, the auxiliary processor (e.g., a neural processing unit) may include a hardware architecture specialized for processing artificial intelligence models. The artificial intelligence models may be generated through machine learning. This learning can take place, for example, on the electronic device (130) itself or on a separate server. The learning algorithms may include, for example, supervised learning, unsupervised learning, semi-supervised learning, or reinforcement learning, but are not limited to the aforementioned examples.

The artificial intelligence model may include multiple layers of artificial neural networks. The artificial neural networks can be deep neural networks (DNN), convolutional neural networks (CNN), recurrent neural networks (RNN), restricted Boltzmann machines (RBM), deep belief networks (DBN), bidirectional recurrent deep neural networks (BRDNN), deep Q-networks, or a combination of two or more of the above, but are not limited to the aforementioned examples. The artificial intelligence model may include, in addition to the hardware architecture, a software architecture as well.

Furthermore, the operations of the electronic device (130) described below may be understood as the operations of the processor (210).

The memory (230) may include non-volatile memory implemented as a secondary storage device, such as an SSD (Solid State Drive) or HDD (Hard Disk Drive), used to store all data necessary for the electronic device (130), and may also include a primary storage device implemented as volatile memory, such as RAM (Random Access Memory). Additionally, the memory (230) may include multiple instructions that direct the operations of the processor (210) to implement the functions provided by the service. In this case, the processor (210) may include a software server that executes the functions provided by the service based on the multiple instructions stored in the memory (230).

The user input/output unit (250) may include an environment for receiving user input and an environment for outputting specific information to the user. For example, the user input/output unit (250) may include input devices such as a touch pad, touch screen, virtual keyboard, or pointing device, as well as output devices such as a monitor or touch screen. In one embodiment, the user input/output unit (250) may correspond to a computing device accessed via remote access, in which case the electronic device (130) may function as a server.

The network input/output unit (270) may include an environment for connecting to external devices or systems via a network, and may include adapters for communication such as LAN (Local Area Network), MAN (Metropolitan Area Network), WAN (Wide Area Network), and VAN (Value Added Network).

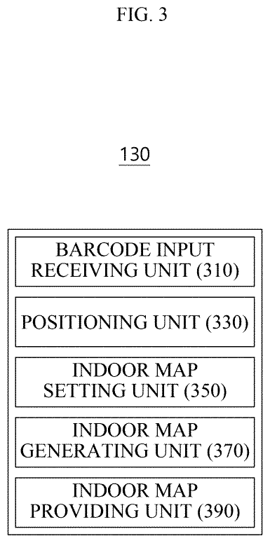

FIG. 3 is a diagram illustrating the functional configuration of a barcode-based indoor map providing apparatus according to one embodiment of the present invention. Referring to FIG. 3, the barcode-based indoor map providing apparatus may include a barcode input receiving unit (310), a positioning unit (330), an indoor map setting unit (350), an indoor map generating unit (370) and an indoor map providing unit (390). Here, the operations by the barcode input receiving unit (310), the positioning unit (330), the indoor map setting unit (350), the indoor map providing unit (390), and the indoor map generating unit (370) may be performed by the processor.

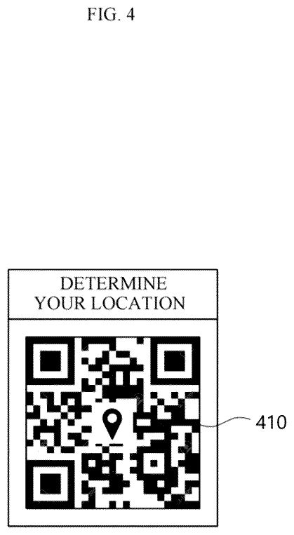

Referring to FIG. 4, the barcode input receiving unit (310) may receive input regarding the barcode (410) from the user terminal (110). For example, the user may input the barcode (410) through the user terminal (110), and the barcode input receiving unit (310) may receive the barcode input from the user terminal (110).

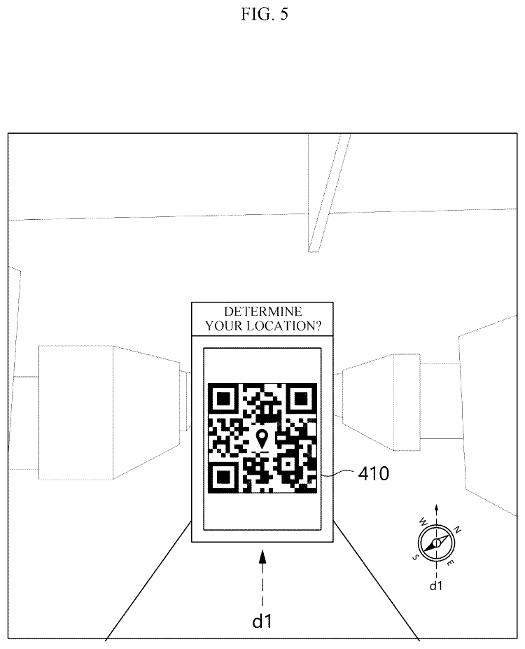

Referring to FIG. 5, in one embodiment, the barcode (410) may be located in an indoor environment and provide an entry point to access the indoor map (610) on the user terminal (110). Specifically, the barcode (410) may be installed at a specific position and in a specific direction indoors. The barcode input receiving unit (310) may receive input from the user terminal (110) regarding the barcode (410) located at a specific position and in a specific direction. For example, the barcode (410) may be installed at a specific position (x1, y1, l1) and in a specific direction (d1) indoors, and the barcode input receiving unit (310) may receive input regarding the barcode (410) from the user terminal (110). Through this, the positioning unit (330) may determine the position and orientation of the user terminal (110), which will be explained in more detail below.

Here, the barcode may be a QR code. Additionally, the type of barcode is not limited to this and may include similar two-dimensional or three-dimensional codes. For example, the barcode may be a code such as a Data Matrix Code, an Aztec Code, or a PDF417 Code

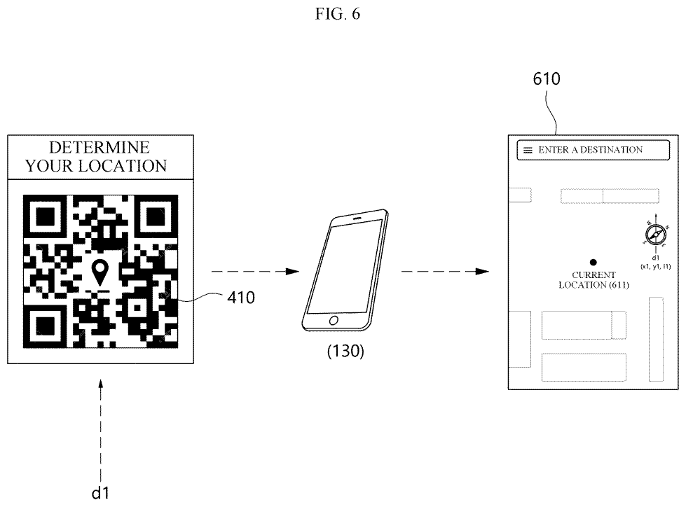

Referring to FIG. 6, the positioning unit (330) may determine the position and orientation of the user terminal (110) on the indoor map based on the position and orientation corresponding to the barcode. Here, the indoor map refers to a map displayed on the user terminal (110), which may be pre-generated by the controller. Additionally, the indoor map may be generated through the indoor map generating unit (370), which will be explained in more detail below. Specifically, the positioning unit (330) determines the position and orientation of the user terminal (110) as the current location (611) based on the position and orientation corresponding to the barcode located in the indoor environment, providing information so that the user can accurately identify their location. That is, the positioning unit (330) may determine the position and orientation of the user terminal (110) based on the barcode data received from the barcode input receiving unit (310). In one embodiment, the position of the user terminal may include layers and coordinates. For example, the positioning unit (330) may determine the position of the user terminal as the current location (611) with coordinates (x1, y1, l1), where x1 and y1 represent the two-dimensional position of the user terminal, and l1 represents the floor on which the user terminal is located in the indoor map. Additionally, the positioning unit (330) may determine the orientation of the user terminal as d1, which may correspond to the direction in which the barcode is viewed from the front.

In one embodiment, the positioning unit (330) may determine the orientation of the user terminal (110) as the front-facing direction of the barcode, which is located at specific layers and coordinates in the indoor environment. Specifically, while determining the current position of the user terminal (110), the positioning unit (330) may also determine the orientation of the user terminal (110). The positioning unit (330) may determine the orientation of the user terminal (110) as the front-facing direction of the barcode, which is located in the indoor environment, as direction d1. For example, if the front-facing direction of the barcode in the indoor environment is northeast, the positioning unit (330) may determine the orientation of the user terminal (110) as 45 degrees. In another example, if the front-facing direction of the barcode in the indoor environment is east, the positioning unit (330) may determine the orientation of the user terminal (110) as 90 degrees. In other words, the positioning unit (330) may determine the position and orientation of the user terminal (110) based on the position and direction of the barcode located in the indoor environment.

In one embodiment, the positioning unit (330) may determine the direction of the user terminal as north by default. Specifically, the positioning unit (330) may determine the direction of the user terminal as north, regardless of the direction of the barcode. For example, if the direction of the barcode is 45 degrees, the positioning unit (330) may determine the direction of the user terminal (110) as 0 degrees. In another example, if the direction of the barcode is not set, the positioning unit (330) may determine the direction of the user terminal (110) as 0 degrees. In other words, the positioning unit (330) may or may not incorporate the direction of the barcode depending on the design of the controller.

The indoor map setting unit (350) may generate an indoor map setting that reflects the position and direction of the user terminal (110) on the indoor map. The indoor map setting unit (350) may generate an indoor map setting that allows the user to determine their current position through the user terminal (110). Specifically, the indoor map setting unit (350) may generate an indoor map setting where the current location and direction of the user are displayed on the pre-generated indoor map. Additionally, the indoor map setting unit (350) may generate the indoor map setting to immediately display information about the location where the user is situated. For example, if the barcode located at a specific company is read by the user terminal (110), the indoor map setting unit (350) may generate an indoor map setting that includes information about the specific company and the user's position on the indoor map displayed on the user terminal (110). Here, the indoor map may be pre-generated, and this will be explained in more detail below.

In one embodiment, the indoor map setting unit (350) may generate an indoor map setting that displays the position and orientation of the user terminal (110) on the indoor map and includes an input window for entering a destination. Specifically, the indoor map setting unit (350) may generate an indoor map setting that displays the user's position and direction on the pre-generated indoor map while allowing the user to input their desired destination. Through this, the indoor map setting unit (350) can provide quick indoor navigation by allowing the user to enter a desired destination immediately.

In one embodiment, the indoor map setting unit (350) may generate an indoor map setting that displays the position and direction of the user terminal (110) on the indoor map and includes an address that can be shared to communicate the location of the user terminal (110). Specifically, the indoor map setting unit (350) may display the determined position of the user on the indoor map in response to the user terminal (110) reading a barcode located in the indoor environment, providing a sharing link to the user terminal (110) that allows the user to immediately share this information with others. In other words, by simply reading a barcode located in the indoor environment, the user can instantly copy a link containing their location information. This allows the user to share their location with others in a crowded public space.

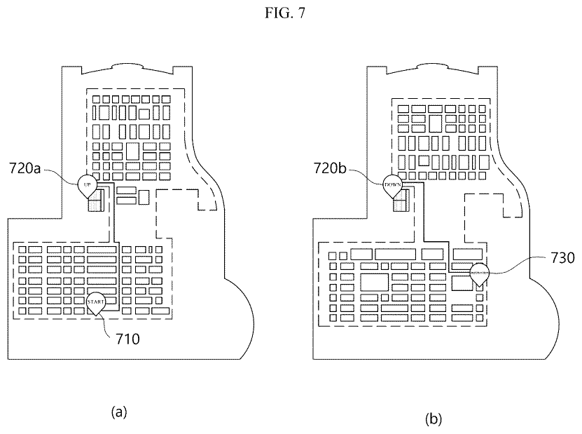

Referring to FIG. 7, the indoor map generating unit (370) may generate a route from the position and orientation of the user terminal (110) to the destination in response to receiving the destination via the input window of the indoor map setting from the user terminal (110). Specifically, after creating the indoor map setting and providing the corresponding indoor map setting to the user terminal (110), the indoor map generating unit (370) may generate a route from the user's position to the destination upon receiving the destination input from the user terminal (110). Here, the entire route from the user's position to the destination may include floor-by-floor routes and segmented routes. Each floor-by-floor route may consist of the route between the starting point and the inter-floor transportation means. Further, a floor-by-floor route may consist of the route between two inter-floor transportation means. Furthermore, a floor-by-floor route may also consist of the route between the inter-floor transportation means and the destination. For example, the indoor map generating unit (370) may generate a route from the starting point (710) to the destination (730) based on the input of the destination (730). Specifically, the indoor map generating unit (370) may generate the route from the starting point (710) to the inter-floor transportation means (720a) as the first-floor route and generate the route from the inter-floor transportation means (720b) to the destination (730) as the second-floor route.

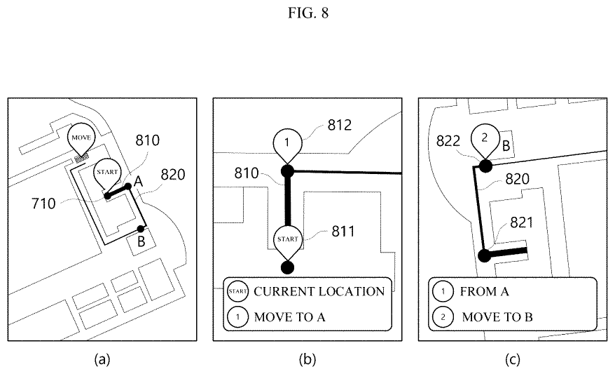

Referring to FIG. 8, in one embodiment, the route from the position and direction of the user terminal (110) to the destination may include multiple segmented routes—each segmented route comprising a sub-start point and a sub-destination point. Here, the segmented routes may be generated by the indoor map generating unit (370), as described above. In another embodiment, the segmented routes may be generated by the route generating unit (1230). In other words, the route generating unit (1230) can fulfill the same role as the indoor map generating unit (370). The segmented routes may be the routes displayed in one unit on the user terminal (110). For example, the segmented routes may be displayed on one page of the user terminal (110), and when the user performs a swipe gesture on the user terminal (110), the next segmented route may be displayed. Here, a segmented route may be the route from the sub-start point to the sub-destination point. For example, the first segmented route (810) may be the route from the first sub-start point (811) to the first sub-destination point (812). In another example, the second segmented route (820) may be the route from the second sub-start point (821) to the second sub-destination point (822). The floor-by-floor routes may include these segmented routes. By generating the floor-by-floor routes as a collection of segmented routes, the indoor map generating unit (370) may allow the user to easily and intuitively check the route.

In one embodiment, the distance from the sub-start point to the sub-destination point may be less than or equal to a preset distance. That is, the indoor map generating unit (370) may generate segmented routes so that each route is within the preset distance. For example, the indoor map generating unit (370) may determine the distance of a single segmented route to be within 5 meters. In a specific example, if the distance from point A to point B exceeds 5 meters, the indoor map generating unit (370) may generate the route from point A to point B as multiple segmented routes.

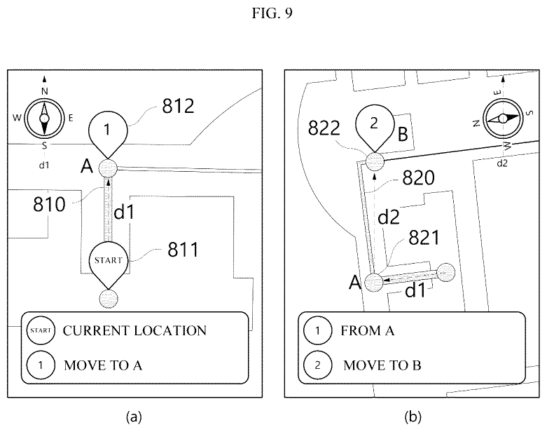

Referring to FIG. 9, in one embodiment, the indoor map generating unit (370) may determine the straight-line direction from the sub-start point to the sub-destination point as the optimal direction. In another embodiment, the route generating unit (1230) may determine the straight-line direction from the sub-start point to the sub-destination point as the optimal direction. In other words, the route generating unit (1230) may perform the same function as the indoor map generating unit (370). The indoor map generating unit (370) may generate a route from the position and direction of the user terminal (110) to the destination so that the segmented routes are displayed in the optimal direction on the user terminal (110). Specifically, the indoor map generating unit (370) may determine the straight-line direction from the sub-start point to the sub-destination point as the optimal direction and generate a route from the position and direction of the user terminal (110) to the destination, displaying it so that the optimal direction points upward. In other words, the indoor map generating unit (370) may generate multiple segmented routes so that the optimal direction is oriented upwards. For example, the indoor map generating unit (370) may determine the direction from the first sub-start point (811) to the first sub-destination point (812) as d1 and generate the first segmented route (810) to be displayed in the d1 direction. In another example, the indoor map generating unit (370) may determine the direction from the second sub-start point (821) to the second sub-destination point (822) as d2 and generate the second segmented route (820) to be displayed in the d2 direction.

The indoor map providing unit (390) may provide the indoor map setting to the user terminal (110). Additionally, the indoor map providing unit (390) may provide the generated route to the user terminal (110).

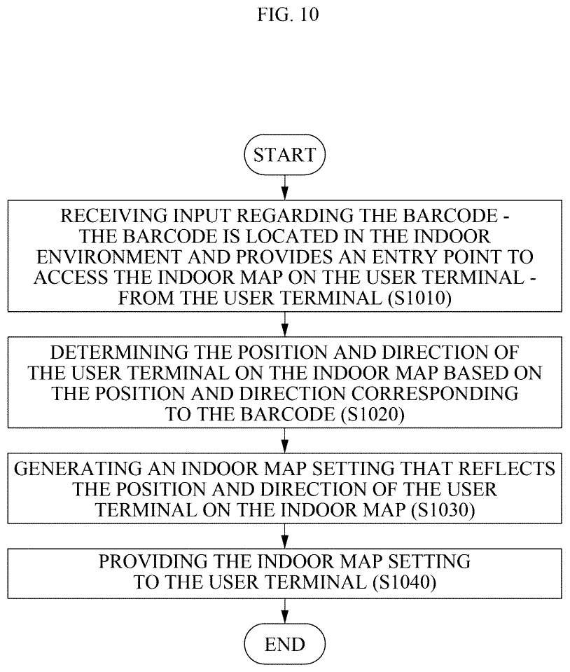

Referring to FIG. 10, the barcode-based indoor map providing method may receive input regarding the barcode—the barcode is located in the indoor environment and provides an entry point to access the indoor map on the user terminal—from the user terminal (S1010).

The barcode-based indoor map providing method may determine the position and direction of the user terminal on the indoor map based on the position and direction corresponding to the barcode (S1020).

The barcode-based indoor map providing method may generate an indoor map setting that reflects the position and direction of the user terminal on the indoor map (S1030).

The barcode-based indoor map providing method may provide the indoor map setting to the user terminal (S1040).

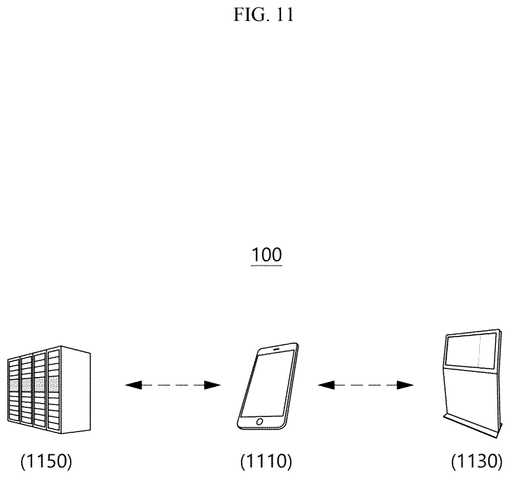

FIG. 11 relates to a barcode-interlinked indoor navigation system according to one embodiment of the present invention. Referring to FIG. 11, the system (1100) may include a user terminal (1110), an electronic device (1130), and a server (1150).

The user terminal (1110) may be implemented as a smartphone or wearable device capable of checking the data generated by the electronic device (1130) and the metadata analyzed from it. However, it is not limited to these devices and may also be implemented on various devices such as a tablet PC. The user terminal (1110) may be connected to the electronic device (1130) via a network, and multiple user terminals (1110) may be connected to the electronic device (1130) simultaneously.

In one embodiment, the user terminal (1110) can display a segmented route on a single screen. Here, the segmented route is the route from the sub-start point to the sub-destination point, and the indoor route may include multiple segmented routes. In other words, the indoor route may be displayed on the user terminal (1110) all at once, and it can be shown as segmented routes to allow the user to check the indoor route in more detail. The indoor route and segmented routes will be explained in detail below.

The electronic device (1130) may include a barcode-interlinked indoor navigation apparatus. The electronic device (1130) may be provided in the form of a program of commands to implement this, stored in a computer-readable recording medium, where it can be read by a computer. In other words, the electronic device (1130) may be implemented in the form of a program of commands executable by various computer means, stored on a computer-readable recording medium. Additionally, the electronic device (1130) may be composed of a computer program that sequentially or non-sequentially performs the operations of receiving a route generation request, generating an indoor route corresponding to the request, and generating a barcode containing information about the indoor route. This computer program can be stored on a computer-readable recording medium.

The server (1150) may perform the operation of generating the indoor route in response to the barcode being read by the user terminal (1110) and providing the indoor route to the user terminal (1110). The server may also consist of at least one processor, and like the electronic device (1130), may be provided in the form of a program of commands for generating the indoor route, stored on a computer-readable recording medium. In other words, the server (1150) may be implemented in the form of a program of commands executable by various computer means, stored on a computer-readable recording medium. Furthermore, the server (1150) may function as a storage device that stores the various information generated through the process where the electronic device (1130) receives the route generation request, generates an indoor route corresponding to the request, and generates a barcode containing information about the indoor route.

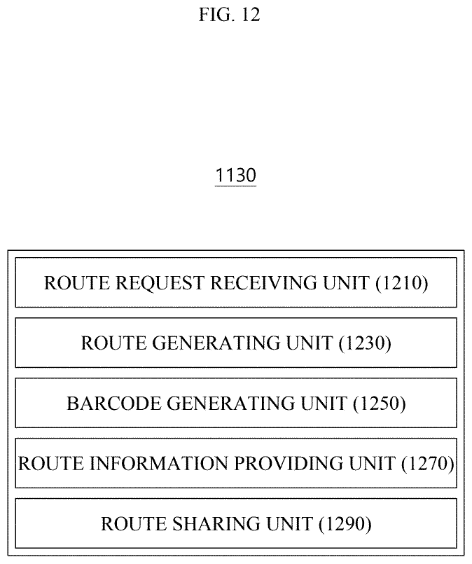

FIG. 12 is a diagram illustrating the functional configuration of a barcode-interlinked indoor navigation system according to one embodiment of the present invention. Referring to FIG. 12, the barcode-interlinked indoor navigation system may include a route request receiving unit (1210), a route generating unit (1230), a barcode generating unit (1250), a route information providing unit (1270), and a route sharing unit (1290). Here, the operations of the route request receiving unit (1210), route generating unit (1230), barcode generating unit (1250), route information providing unit (1270), and route sharing unit (1290) may be performed by the processor.

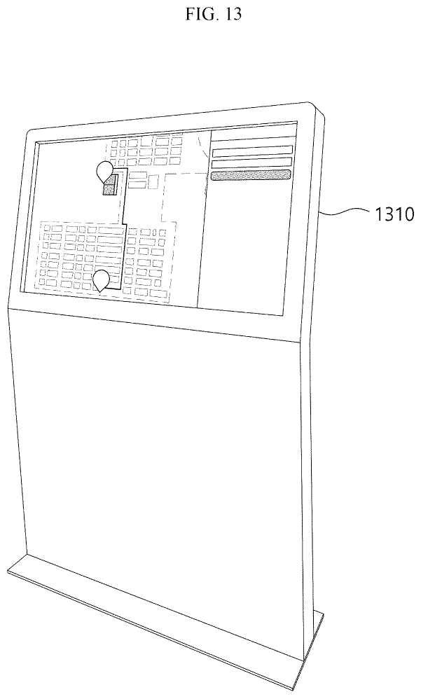

Referring to FIG. 13, the route request receiving unit (1210) may receive a route generation request from a user interface device. The route request receiving unit (1210) may be functionally implemented within the user interface device or the server (1150). That is, the route request receiving unit (1210) may be operated by a processor, and this processor may be configured within the user interface device or the server (1150). Specifically, the route request receiving unit (1210) may receive the user's route generation request as an external input.

For example, the user interface device may be implemented as a kiosk (1310). Specifically, the user interface device may be a device that receives user input and performs processing, and it can be implemented as a kiosk (1310). Additionally, the kiosk (1310) may be placed in an indoor space. For example, the route generation request can be input by the user through the kiosk (1310), and the route request receiving unit (1210) can receive it. As described above, the route request receiving unit (1210) may be functionally implemented within the kiosk (1310).

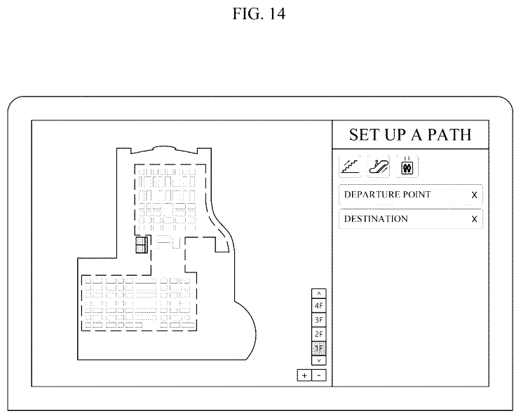

Referring to FIG. 14, the route generation request through the user interface device may include the starting point, destination, and inter-floor transportation means. The route request receiving unit (1210) may receive the route generation request, which includes the starting point, destination, and inter-floor transportation means, through the user interface device. For example, the inter-floor transportation means may include stairs, escalators, and elevators.

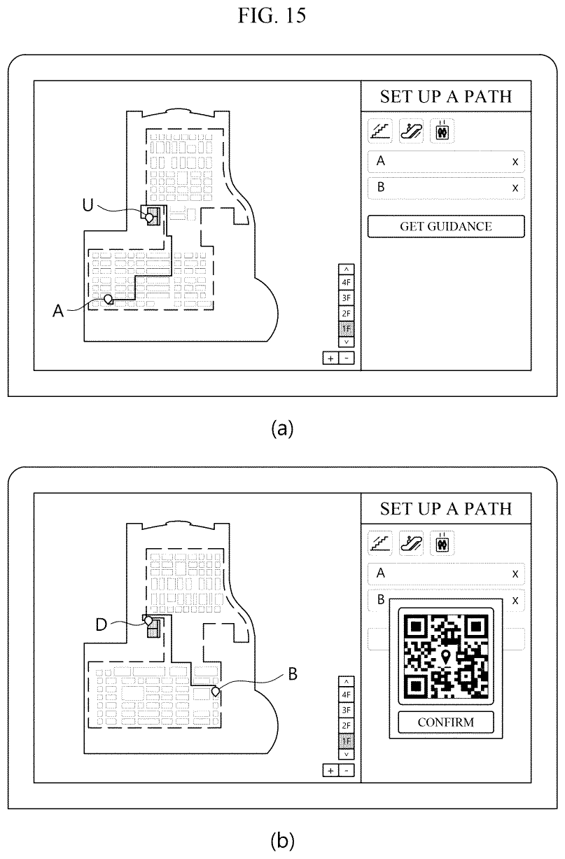

Referring to FIG. 15, the route generating unit (1230) may generate an indoor route that includes the starting point (A) and the destination (B) in response to the route generation request. The route generating unit (1230) may be functionally implemented within the user interface device or the server (1150). That is, the route generating unit (1230) may be operated by a processor, and this processor may be configured within the user interface device and the server (1150). For example, the route generating unit (1230) may generate an indoor route that includes the starting point (A) and the destination (B) based on the information about the starting point and destination received from the user interface device. Inter-floor transportation means may be included between the starting point (A) and the destination (B), which will be explained in more detail below. Here, the indoor route may include floor-by-floor routes. or example, the indoor route from the first floor to the second floor may include the first-floor route and the second-floor route.

Here, the indoor route may include floor-by-floor movement routes that involve inter-floor transportation means (U, D). For example, the route generating unit (1230) may generate the first-floor movement route, second-floor movement route, third-floor movement route, and fourth-floor movement route for the route from the first-floor starting point (A) to the fourth-floor destination (B). In other words, the indoor route may include multiple floor-by-floor routes. For example, when receiving a route generation request for a route from the first-floor starting point (A) to the fourth-floor destination (B) via an escalator, the route generating unit (1230) may generate the first-floor movement route including the escalator (U). Additionally, the route generating unit (1230) may generate the fourth-floor movement route including the escalator (D).

The route generating unit (1230) may include a first route generating unit and a second route generating unit. The first route generating unit and the second route generating unit are functionally divided for convenience in naming and may operate within a single processor or within separate processors.

The first route generating unit may generate a first indoor route that includes the starting point and destination in response to the route generation request. For example, the first route generating unit may generate a first indoor route that includes the starting point (A) and destination (B) based on the information about the starting point and destination received from the user interface device. Inter-floor transportation means may be included between the starting point (A) and the destination (B). For example, the first route generating unit may be functionally implemented within a kiosk. Specifically, the first route generating unit may receive the route generation request through the kiosk input panel and process it independently to generate the corresponding first indoor route.

The second route generating unit may generate a second indoor route in response to the barcode being read via the user terminal (1110). Specifically, the second route generating unit may receive information from the user terminal (1110) that a barcode has been read and generate the second indoor route. For example, after the first indoor route is generated by the first route generating unit, a barcode containing information about the first indoor route is generated, and if the barcode is read by the user terminal, the second route generating unit may generate the second indoor route. Here, the barcode, which may be generated by the barcode generating unit (1250), can include information about the indoor route or the first indoor route, which will be explained in more detail below.

In one embodiment, the second route generating unit may generate a second indoor route identical to the first indoor route based on the information from the first indoor route. Specifically, the information about the first indoor route may include the starting point, destination, and inter-floor transportation means input before generating the first indoor route. For example, the second route generating unit may input the information of the first indoor route contained in the barcode into the route generation process to generate the second indoor route. Additionally, the first route generating unit and the second route generating unit may be implemented using the same route generation process, so that if the starting point and destination are the same, the same indoor route can be generated. In another example, the first route generating unit and the second route generating unit may generate the same indoor route if the starting point, destination, and inter-floor transportation means are the same.

In another embodiment, the information about the first indoor route may include the details of the first indoor route itself. In other words, the second route generating unit may receive the first indoor route itself and generate an identical second route.

The barcode generating unit (1250) may generate a barcode that includes information about the indoor route or the first indoor route. As described above, the barcode generating unit (1250) may include the basic information required to generate the first indoor route. Specifically, the information about the indoor route may include the starting point, destination, inter-floor transportation means, and route generation algorithm necessary to generate the first indoor route.

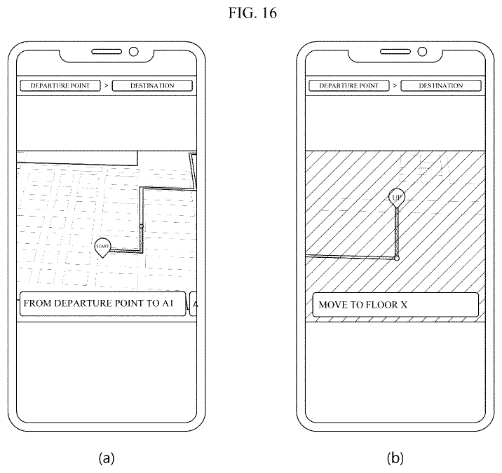

Referring to FIG. 16, the route sharing unit (1290) may provide the indoor route information to the user terminal (110) that has read the barcode. The route sharing unit (1290) may be functionally implemented within the user interface device or the server (1150). That is, the route sharing unit (1290) may operate through a processor, and this processor may be configured within the user interface device or the server (1150). For example, the information about the indoor route may be provided to the server (1150) via the user terminal (1110). In another example, the information about the indoor route may be provided directly to the server (1150) without going through the user terminal (1110).

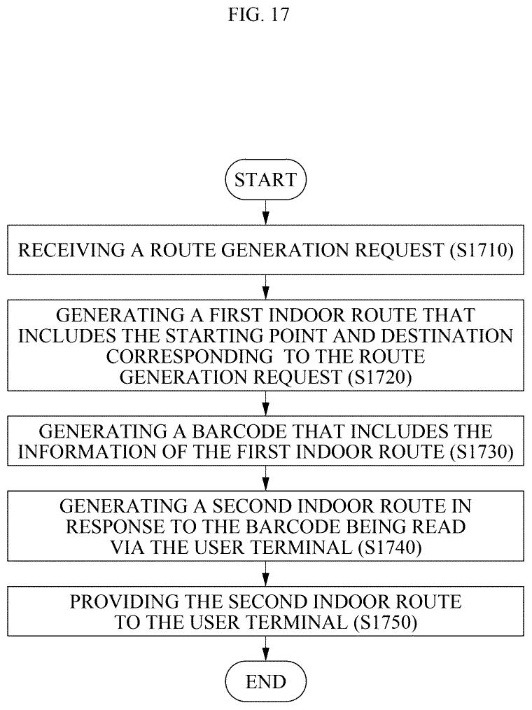

Referring to FIG. 17, the barcode-interlinked indoor navigation method may receive a route generation request (S1710).

Further, the barcode-interlinked indoor navigation method may generate a first indoor route that includes the starting point and destination corresponding to the route generation request (S1720).

Further, the barcode-interlinked indoor navigation method may also generate a barcode that includes the information of the first indoor route (S1730).

Further, the barcode-interlinked indoor navigation method may generate a second indoor route in response to the barcode being read via the user terminal (S1740).

Further, the barcode-interlinked indoor navigation method may provide the second indoor route to the user terminal (S1750).

While the above has been described with reference to preferred embodiments of the invention, it will be understood by those skilled in the art that various modifications and changes can be made to the invention without departing from the spirit and scope of the invention as recited in the following patent claims.

### DESCRIPTION OF REFERENCE NUMBER

100: system
110: user terminal
130: electronic device
150: database
210: processor
230: memory
250: user input/output unit
270: network input/output unit
310: barcode input receiving unit
330: positioning unit
350: indoor map setting unit
370: indoor map generating unit
390: indoor map providing unit
410: barcode
610: indoor map
611: current location
710: starting point
730: destination
810: first segmented route
811: first sub-start point
812: second sub-destination point
820: second segmented route
821: second sub-start point
822: second sub-destination point
1210: route request receiving unit
1230: route generating unit
1250: barcode generating unit
1270: route information providing unit
1290: route sharing unit

1. An electronic device comprising,
a memory comprising at least one instruction; and
at least one processor electrically connected to the memory and configured to execute the at least one instruction,
wherein the at least one processor:
receives an input for a barcode from a user terminal, the barcode being located in an indoor environment and providing an entry for the user terminal to access an indoor map,
determines a position and orientation of the user terminal on the indoor map based on a position and orientation corresponding to the barcode,
generates an indoor map setting incorporating the position and orientation of the user terminal on the indoor map; and
provides the indoor map setting to the user terminal.

2. The electronic device of claim 1,
wherein the barcode is a QR code.

3. The electronic device of claim 1,
wherein the position of the user terminal includes a layer and coordinates.

4. The electronic device of claim 3,
wherein the at least one processor determines an orientation of the user terminal as a frontal direction of a barcode located in the layer and coordinates.

5. The electronic device of claim 1,
wherein the at least one processor determines the orientation of the user terminal with north as a default value.

6. The electronic device of claim 1, wherein the at least one processor generates the indoor map setting, which includes the position and orientation of the user terminal on the indoor map and an input window for entering a destination.

7. The electronic device of claim 6,
wherein the at least one processor generates a route from the position and orientation of the user terminal to the destination in response to receiving the destination in the input window of the indoor map setting from the user terminal.

8. The electronic device of claim 7,
wherein the route from the position and orientation of the user terminal to the destination includes multiple segmented routes, the segmented routes including sub-start and sub-destination points.

9. The electronic device of claim 8,
wherein the at least one processor determines a straight line direction from the sub-start to the sub-destination point as an optimal direction and generates the route from the position and orientation of the user terminal to the destination, displaying the segmented route in the optimal direction on the user terminal.

10. The electronic device of claim 1,
wherein the at least one processor generates the indoor map setting to include a display of the position and orientation of the user terminal on the indoor map and an address for sharing the location of the user terminal.

11. A method performed by a memory and at least one processor electrically connected to the memory, comprising:
receiving an input for a barcode from a user terminal, the barcode being located in an indoor environment and providing an entry for the user terminal to access an indoor map;
determining a position and orientation of the user terminal on the indoor map based on a position and orientation corresponding to the barcode;
generating an indoor map setting incorporating the position and orientation of the user terminal on the indoor map; and
providing the indoor map setting to the user terminal.

12. A computer-readable recording medium combined with hardware, storing a computer program to perform the method of claim 11.
